(19) United States
(12) Patent Application Publication
(10) Pub. No.: US 2005/0005202 A1
(43) Pub. Date: Jan. 6, 2005

(54) Proactive support of a healthcare information system

(76) Inventors: Christopher J. Burt, Essex Junction, VT (US); Kyle W. Lawton, Williston, VT (US); Ronald Keen, Shelburne, VT (US)

Correspondence Address: FENWICK & WEST LLP, SILICON VALLEY CENTER, 801 CALIFORNIA STREET, MOUNTAIN VIEW, CA, 94041, US

(21) Appl. No.: 10/718,781

(22) Filed: Nov. 20, 2003

Related U.S. Application Data
(60) Provisional application No. 60/428,588, filed on Nov. 22, 2002.

(51) Int. Cl. H02H 3/05

(52) U.S. Cl. 714/47

(57) ABSTRACT

Systems and methods are provided for proactively monitoring a healthcare information system. The monitor system has a plurality of counters and one or more notification agents. Counters monitor performance parameters by recording the values of the parameters at a predetermined interval. Multiple counter instances may be implemented. Agents notify designated representatives when the value of a counter exceeds a threshold. Notifications may be escalated as needed. The proactive monitor system may further include an operator capable of performing fixes to bring the value of the counter back within the threshold. Two user interfaces may be included, connecting to a customer support system and a user of the healthcare information system, respectively. The proactive detection, notification, and repair of business or system failures may be performed manually or automatically, onsite or over a network.

### CROSS REFERENCE TO RELATED APPLICATIONS

This application claims the benefit of U.S. Provisional Application No. 60/428,588, filed Nov. 22, 2002.

### BACKGROUND OF THE DISCLOSURE

1. Field of the Disclosure

The present disclosure relates generally to monitoring a computer system for handling hardware and software failures, and more specifically to proactively detecting, notifying, and managing system failures and business performance exceptions in a healthcare information setting.

2. Description of the Related Art

Reliable and robust information systems are central to today's research and commercial undertakings. Timely detection and handling of problems in computer hardware and software and exceptions in business operations is vital to the success of any business enterprise. In a healthcare information setting, it is particularly important that system failures and business performance exceptions be captured and resolved proactively.

Existing approaches of customer or user support for computer systems in general or healthcare information systems in particular are reactive. That is, customer support systems learn about problems associated with software and hardware performance only when customers or users report the problems. This model has a number of drawbacks. Chief among them is that the problems are resolved after they have had negative impact on the system performance.

There is a need for a way to proactively prevent problems and facilitate corrections prior to receiving customer reports and before the problems have a negative impact on the system performance.

### SUMMARY OF THE VARIOUS EMBODIMENTS

The present disclosure provide methods and systems for proactively detecting, notifying, and fixing hardware and software failures as well as business performance exceptions in a healthcare information setting.

The proactive notification may be delivered to a customer or user, or a customer support representative of a healthcare information system. A customer support system of the healthcare information system may receive notifications of system and business performance failures and perform actions in response to the notification. The customer support system, for example, repairs the customer system, reconfigures the healthcare information system, and sends fixes and new updates. The user or customer of the healthcare information system, on the other hand, may respond to the notification of business performance exceptions and adjust business operations accordingly.

The methods and systems of this disclosure are useful to enhance system performance and user satisfaction, as system failures and business performance exceptions can be detected and dealt with before the problems become significant and exert a notable negative impact on the system performance or business in general.

### BRIEF DESCRIPTION OF THE DRAWINGS

FIG. 1 is a high-level block diagram illustrating the proactive support system according to one embodiment of this disclosure.

FIG. 2 is a block diagram of functional modules of a proactive notification agent of the proactive support system, according to one embodiment of this disclosure.

FIG. 3 is a block diagram of a database system of the proactive notification agent, according to one embodiment of this disclosure.

FIG. 4 is a block diagram of a database system of the customer support system shown in FIG. 1, according to one embodiment of this disclosure.

FIGS. 5 and 6 are flow charts illustrating steps performed by the proactive notification agent, customer support system, and customer system, according to one embodiment of this disclosure.

The figures depict certain embodiments of the present disclosure for purposes of illustration only. One skilled in the art will readily recognize from the following description that alternative embodiments of the structures and methods illustrated herein may be employed without departing from the principles of the various embodiments of this disclosure.

### DETAILED DESCRIPTION OF THE VARIOUS EMBODIMENTS

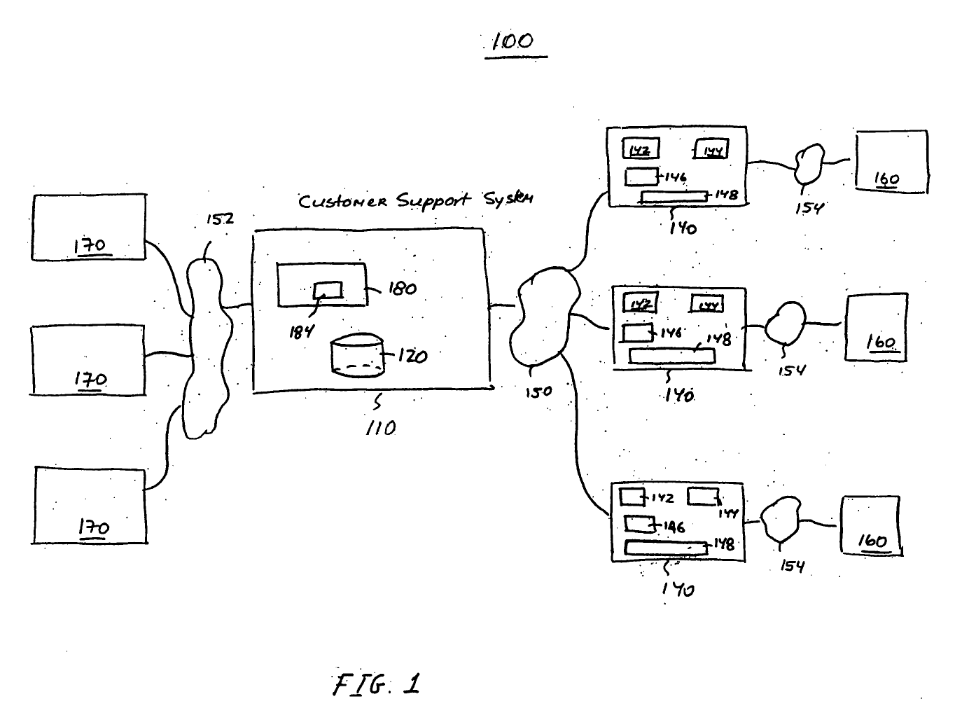

FIG. 1 is a high-level block diagram of a proactive support system 100 according to an embodiment of the present disclosure. System 100 includes a customer support system 110 which can be accessed by a plurality of customer systems 140 via communication link 150. Each customer system 140, in turn, is in communication with customer consoles 160 via another communication link 154. Customer support system 110 is in communication with customer support representative consoles 170 via yet another communication link 152.

FIG. 1 shows three customer systems 140, one console 160 connected to each respective customer support system 140 and three customer support representative consoles 170 connected to customer support system 110. It should be understood, however, that customer support system 110 may be in communication with any number of customer systems 140. Similarly, more than one console 170 may be connected to customer support system 110 and more than one console 160 may be connected to customer system 140. This description often refers to a single customer system 140, console 160 and customer support representative console 170 for purposes of convenience and clarity.

In one embodiment, customer system 140 executes a healthcare information system. A healthcare information system, according to one embodiment, includes at least one database capable of storing patient data and at least one user interface capable of presenting the patient data and receiving user input. The patient data refers to relevant physiological, genetic, and biochemical measurements of patients, among other things. The healthcare information system is capable of processing the patient data for suitable diagnosis and treatment. In another embodiment, the database is further capable of storing information of clinical procedures, billing, and medical insurance and the healthcare information system is capable of processing this information thereby managing patient billing.

Customer system 140 includes typical computing elements such as memory 142, a processor 144 and a storage device (not shown). Customer system 140 runs a database system 146. Processor 144 may be any specific or general-purpose processor such as an INTEL x86 or POWERPC-compatible central processing unit (CPU). The storage device may be any device capable of holding large amounts of data, like a hard drive, compact disk read-only memory (CD-ROM), DVD, or some other form of fixed or removable storage device. Memory 142 holds instructions and data used by the processor 144. Because in the preferred embodiment customer system 140 executes a healthcare information system, database 146 preferably stores patient-related data.

In various embodiments, the communication links 150, 152, and 154 are supported by a local, wide area, or global computer and communications networks, wired or wireless.

Customer system 140 also operates a proactive notification agent (“agent”) 148. Agent 148 polls data on customer system performance. Agent 148 transforms the data into counters and detects whether the counters exceed thresholds. Counters counts occurrences of events. According to various embodiments, they are capable of monitoring one of a multiplicity of business or system performance parameters by recording the values of the parameters at predetermined intervals. Some counters may be further defined with specific system, organizational, or business details to create counter instances. One or more counter instances may be created for each counter according to certain embodiments. A counter instance may monitor and record certain specific aspects or details of a counter. A counter may be implemented as a generic counter object. In alternative embodiments, the counter of the proactive notification system may be separated from and independent of the notification agent.

Agent 148 notifies customer support system 110 when the counters or counter instances exceed thresholds specified by customer support system 110 or by user s or customers of the healthcare information system. Agent 148 also notifies customers (or customer support system 110) when the counters exceed thresholds specified by customers or users. A user or customer of a healthcare information system refers to, among other things, a doctor, a nurse, a healthcare administrator, or an insurance specialist. Threshold, as used in this disclosure, refers to a value that marks a boundary indicating a level of concern. A threshold may concern hardware or software system performance as well as business operational status. In various embodiments, thresholds may be predetermined by either the customer support system or the customer (user) of the healthcare information system.

Notifications may be delivered to a designated representative, such as a customer representative, or a customer (user), as desired. The designated representative may be a human or an automated system or process. In one embodiment, the designated representative may be responsible for one or more counters, such that the notification concerning these counters are forwarded to the designated representative. In another embodiment, the designated representative may be responsible for one or more healthcare information systems, such that all notifications concerning these healthcare information systems are forwarded to the designated representative. A designated customer representative may be associated with the customer support system 110. That is, for example, the customer support system 110 may have appointed one or more customer representatives who are responsible for one or more counters according to various embodiments.

In one embodiment, the proactive support system 110 further includes an operator capable of performing necessary fixes in response to the notified problems. By repairing the problems, the operator thus brings the value of the counter or counter instance back within the prescribed threshold. The operator may be a human or an automated system or process. The operator may manually or automatically performing the necessary fixes. In certain embodiments, the operator is part of the customer support system. For example, once a notification is acknowledged, the customer support system may repair the customer system, reconfigure the healthcare information system, or send fixes and new updates. In other embodiments, the operator is part of the customer system, which allows the user or customer to respond to the notification of business performance exceptions and adjust business operations accordingly.

In a further embodiment, if no acknowledgement is received after a predetermined period of time, the notification agent 148 escalates the notification to a higher tier. That is, the agent delivers the notification to a designated representative of a higher level. For example, a support manger may be paged after one hour if no acknowledgement is received back from the earlier notification delivered to a support engineer. Similarly, a director may be notified if no acknowledgement is received after a predetermined period of time elapsed. Thus, the notification agent may escalate the notification to one or more representatives of consecutively higher tiers, when no acknowledgement is received after a predetermined period at each tier. The predetermined time period may be, for example, 10 minutes, 15 minutes, 20 minutes, 30 minutes, 45 minutes, and 1 hour, in various embodiments.

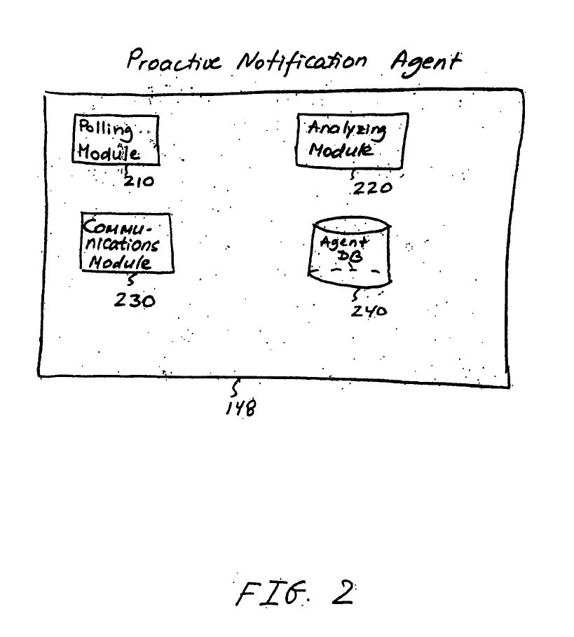

Agent 148 is preferably a module. As used herein, the term “module” refers to computer program logic, whether incorporated into any hardware, software, or firmware to provide the functionality attributed to the module. In one embodiment, agent 148 runs as a Windows service (e.g., Web-Based Enterprise Management, Windows Management Instrumentation) on customer system 140. Functional modules within agent 148 are described below in reference to FIG. 2.

In one embodiment, a customer uses console 160 to communicate with agent 148. Console 160 preferably includes a display for displaying notifications received from agent 148. Console 160 also includes an input device for providing data input. In one embodiment, console 160 is a computer system executing a user interface module for interfacing with agent 148. In one embodiment, the user interface module provides a graphical user interface (GUI) for accessing agent 148. In another embodiment, the user interface module is web browsing software operating as a client that accesses agent 148 via communication link 154. The user interface may be command line based or graphical. The user interface module preferably makes application program interface (API) calls to agent 148 to request counters for display. This allows customers to view counters using console 160. The customer also receives notifications from agent 148 on customer system performance when counters exceed thresholds specified by the customer. These notifications are received on console 160 as asynchronous alerts that may be visible, audible, and/or tactile. Console 160 may be a pager, a telephone, a personal digital assistant (PDA), etc, in various embodiments.

The proactive notification system in one embodiment includes a user interface connected to a user of the healthcare information system. In another embodiment, the proactive notification system includes a second user interface connected to a customer support system of the healthcare information system. The user interfaces are capable of displaying the information about the counters and thresholds and their relationships.

Communication link 154 coupling console 160 to customer system 140 is preferably a network connection such as a local area network (LAN), a wide area network (WAN), a telephone network, a pager network, etc., as described above. Data can be sent as an email message using simple mail transfer protocol (SMTP). Data can also be sent as a web page using hypertext transfer protocol (HTTP) and secure hypertext transfer protocol (HTTPS). Data may be encoded in the extensible markup language (XML) or any other representation.

Customer support system 110 receives notifications from agent 148 when customer system 140 performance exceeds specified thresholds. Customer support system 110 performs actions in response to the received notifications. Among the actions performed by customer support system 110 are repairing customer system 140, providing updates to customer system 140, and/or reconfiguring customer system 140. In one embodiment, customer support system 110 receives notifications from agent 148 over communication link 150. Communication link 150 is preferably a network connection such as Internet. In one embodiment, notifications are sent as an email message using SMTP. In another embodiment, notifications are sent as a web page using HTTP and HTTPS. Notifications may be encoded in the XML or any other representation. Thus, notifications may be delivered through a Personal Digital Assistant, pager, landline or mobile phone, radio broadcast, among other things.

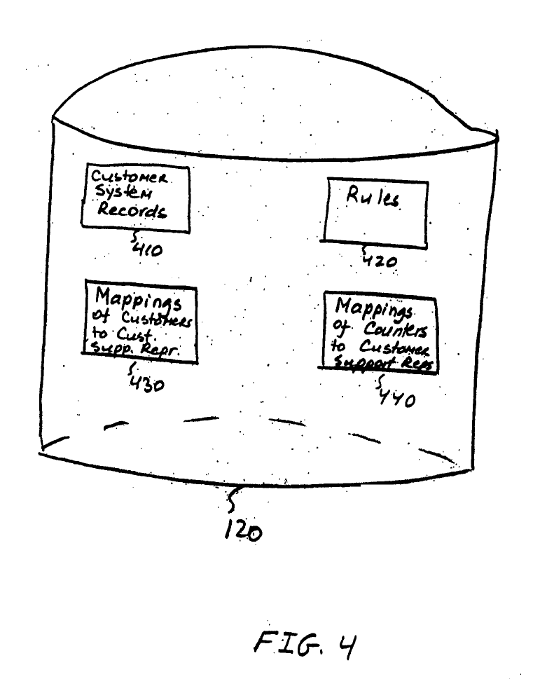

In one embodiment, the customer support system 110 includes a customer system database 120 and an application server 180. Customer system database 120 stores customer system records, including the performance data of the healthcare information system. Customer system database 120 also stores mappings of customer systems 140 to customer support representatives. Customer system database 120 also stores mappings of counters to customer support representatives and a set of rules for responding to received notifications. Customer system database 120 is described in more detail in reference to FIG. 4.

Application server 180 includes modules providing functionality attributed to customer support system 110. Application server 180 receives notifications on customer system performance from agent 148. The notifications include a customer system ID that uniquely identifies the customer systems from which the notifications were received. In one embodiment, application server 180 executes rules stored in customer system database 120 to perform actions in response to the notifications received from agent 148. Application server 180 uses data stored in database 120 to map the customer system ID to a customer support representative that is responsible for the particular customer system and sends notifications to that customer support representative. This way, a customer support representative that is responsible for the customer system 140 identified by the customer system ID will be notified.

In another embodiment, application server 180 uses the data stored in database 120 to map counters for which the threshold is exceeded to a customer service representative that is responsible for attending to the type of problem indicated in the received notification. When customer support system 110 receives a notification from agent 148, it updates a corresponding customer system record in database 120. Similarly, customer support system 110 updates a corresponding customer system record when it performs an action in response to the received notification.

Application server 180 preferably includes an email server 184 that allows customer support system 110 to send and receive electronic messages to/from agent 148. In one embodiment, email server 184 uses known protocols, such as Post Office Protocol (POP3) or Internet Message Access Protocol (IMAP) to retrieve electronic messages.

A customer service representative uses console 170 to communicate with customer support system 110. Console 170 preferably includes a display to view received notifications and an input device for providing data input. In one embodiment, console 170 is a computer system executing a user interface module for interfacing with customer support system 110. In one embodiment, the user interface module provides a GUI for interfacing with customer support system 110. The user interface module preferably makes API calls to agent 148 to request counters that were provided for display to the customer at console 160. A customer support representative receives notifications from customer support system 110 on customer system performance. Notifications can be sent as an email message using SMTP. Notifications can also be sent as a web page using HTTP and HTTPS. Console 170 can also be a pager, a telephone, a PDA, etc.

Communication link 152 coupling console 170 to customer support system 170 is preferably a network connection as described above with respect to link 154.

FIG. 2 shows functional modules within agent 148. Agent 148 includes a polling module 210, an analyzing module 220, a communications module 230 and a database 240. Polling module 210 is preferably configured to gather data about the customer system 140 and transform the data (if necessary) into a counter. In one embodiment, the data is transformed into a numeral, which is capable of being recorded by a counter of the proactive notification system. Polling module and counter may be used interchangeably in certain embodiments. Multiple counter instances are supported in alternative embodiments. In one embodiment, polling module 210 abstracts the data as a numerical value or other similar format. In another embodiment, polling module 210 polls the database 146 for data and generates counters from these data. Polling module 210 also reads data already formatted as counters using known data collecting systems. Examples of such data collecting systems include Microsoft Operations Manager (MOM), HP Open View, Tivoli, and NetIQ. Agent 148 also can make API calls to the operating system using ConnectR, a product provided by IDX Systems Corporation of Burlington, Vt. Polling module 210 preferably stores the counters in database 240.

Examples of data monitored by the counter or the polling module 210 include:

Clinical Data:
number of waiting patients
count of unresolved mammography recommendations
size of order entry queue
transcription backlog
overdue diagnostic reports.

Business Data:
Count of unresolved billing exceptions
Size of ICD9 Coding Queue

System Data:
Operating System/Hardware
Free Space on Disk Drives
Status of components (i.e. Power Supply, Disk Errors, Network Card)
Status of print queues
Status of key services such as Microsoft Message Queue (MSMQ), Internet Information Server (IIS), SQL Server, SQL Server Agent.

Database Data:
Free Space of data volumes/transaction logs
Status of maintenance jobs
Status of database backups
Number of outstanding database locks.

Connectivity Data:
Interface status
Interface transaction backlog
Interface error log
Transaction throughput.

System Performance Data:
CPU Utilization
Average response time per page
Duration of reporting.

Change Control (Changes to System Configuration):
Changes to system definition
Installation/Upgrade of layered products (e.g. Installation of SQL service pack).

Security Data:
Repeated attempts to gain unauthorized access to the system
Repeated attempts to gain unauthorized access to privileged data

Examples of the counters are:
Status of last Database Backup Job
Counter of entries Merge Candidates List
Status of Application Service
Application Status/Counters
Interface Backlog (Queued Transactions) for each interface
Error Count for each interface
Interface Status
Time since Last Transaction Processed
Average Transaction Time per interface
Counter of exams in “Ordered” status (Order Entry Queue Backlog)
Counter of exams in “Scheduled” status before time threshold (No Show Report)
Counter of exams in “In Progress” status (Incomplete Exams Report)
Counter of exams in “Complete” status (Read Backlog)
Counter of exams in “Dictated” status (Transcription Backlog)
Counter of exams in “Preliminary”, “Addended”, and “Revised” Status (Outstanding Reports Display)
Status of Fax Service
Count of unsent Faxes
Count of failed Faxes
Count of errored entries in the Report Directory
Count of Logged in Users.
Status of Bar Code Service
Status of Task Manager Service
Count of Billing Exceptions
Count of ICD9 Coding Queue Entries
Count of Acquisition Exceptions
Status of Print Jobs
Count of customer support system errors in Windows Event Log
Count of unresolved mammography recommendations
Count of outstanding application locks (by Lock Type)
Status of nightly Database Maintenance jobs
Count of failed login attempts
Count of outstanding SQL server locks/hung transactions
Ability to Monitor Operating System/Hardware status/counters
Disk Errors
Disk Free Space
CPU Utilization
Memory Utilization
Network Bandwidth
SQL Server Service Status
MSMQ Service Status
Status of other key services

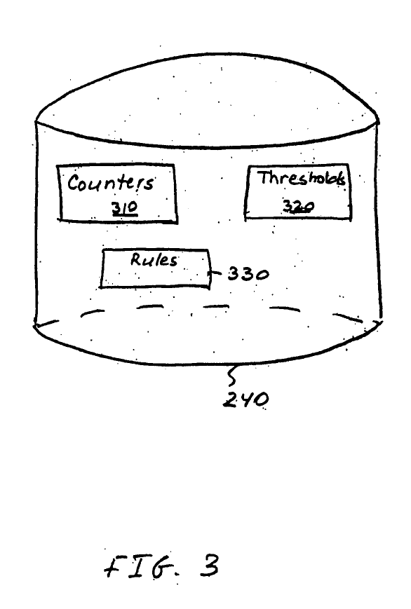

FIG. 3 shows agent database 240. As previously described, agent database 240 stores information on counters 310. Agent database 240 also stores thresholds 320 for counters as specified by customers and customer support system 140 using consoles 160 and 170 respectively. In one embodiment, customers and customer support system 140 may specify more than one threshold for each counter or counter instance. Database 240 also stores rules 330 indicating what actions need to be taken when thresholds are exceeded. Each rule has a unique primary key. Rules may specify an email address, phone number, facsimile number or pager number where notifications should be sent. Rules may specify the number of repeat notifications for each threshold. Rules may specify duration between repeat notifications for each threshold. Thresholds and rules are used by analyzing module 220 and communications module 230 shown in FIG. 2. Database 240 also stores knowledge-based information that includes knowledge-based articles. Customers at customer system 140 can access these articles. In one embodiment, thresholds, rules, and knowledge-based information are stored in XML format.

Referring again to FIG. 2, analyzing module 220 of agent 148 is preferably adapted to receive information gathered by pulling module 210 which are transformed into counters and to compare the counters to the customer-specified thresholds and thresholds specified by customer support system 110 stored in database 240. Analyzing module 220 executes rules 330 to determine what actions need to be taken in response to the comparisons. Actions indicate notifications that need to be sent to customers and customer support system 110 when counters exceed customer thresholds and customer support thresholds.

Communications module 230 is adapted to route notifications in the form of messages to customers and customer support system 110 according to the rules stored in database 240. Each notification preferably includes a customer system ID and an indication that a particular counter or counter instance exceeded a threshold. Communications module 230 routes notifications by sending an email, sending a page, making a phone call, etc. Rules 240 stored in database 240 indicate the number of notifications per customer system 140. For example, when counters indicate that a database server of customer system 140 encounters an error, communications module 230 sends multiple messages to customers according to the rules stored in database 240.

FIG. 4 is a block diagram of database 120 of customer support system 110. The database 120 holds customer system records 410. Each customer system record 410 contains fields for storing data associated with the record. Each field can hold data in the form of numeric, textual, binary information, and any other data type adapted for storage in a database. In one embodiment, each customer system record includes a customer system ID, a customer name, name of the product that is executing on customer system 140, installation date, status of customer system 140, and the date of the product update. Of course, other data may be included as desired. As previously described, customer system database 120 also stores mappings 430 of customer systems 140 to customer support representatives assigned to perform an action in response to the received notifications with respect to the customer system 140 identified by the customer system ID. Customer system database 120 also stores mappings 440 of counters to customer support representatives assigned to perform an action in response to the notification with respect to counters exceeding a threshold. Customer system database 120 also stores a set of rules 420 for responding to received notifications.

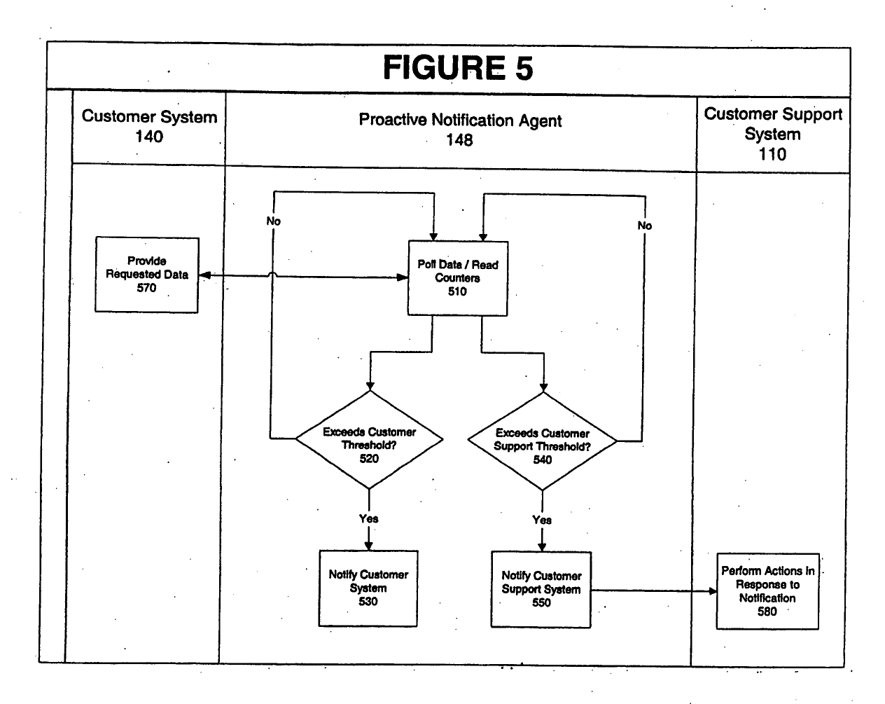

FIG. 5 is a flow chart of steps performed by agent 148, customer system 140 and customer support system 110 according to one embodiment. Agent 148 polls 510 customer system 140 for data on customer system performance. Agent 148 transforms the data into numerals that are capable of being recorded by counters, if necessary. Agent 148 reads the counters 510 from the customer system 140. Agent 148 determines 520 if the counters exceeded thresholds specified by customers. If so, agent 148 sends 530 notifications to customer system 140. If the counters do not exceed thresholds, agent 148 continues polling customer system 140 for data.

Agent 148 also determines 540 whether the counters reached thresholds specified by customer support system 110. If so, agent 148 notifies 550 customer support system 110 to indicate that the counters reached the thresholds. In step 580 customer support system 110 receives notifications from agent 148 and performs actions in response to the notification. Among the actions performed by customer support system 110 are providing hot fixes, updates, system reconfigurations, patches and repairs. If the counters do not exceed thresholds, agent 148 continues polling customer system 140 for new data.

Notifications to the customer system 140 may be forwarded to the customer support system 110, and vice versa, in alternative embodiments. As such, the custom support system 110 may be informed of the potential problematic events according to the customer-defined thresholds and, the user, through the custom system 140, may be notified as needed when certain events exceeding the threshold defined by the customer support system 110.

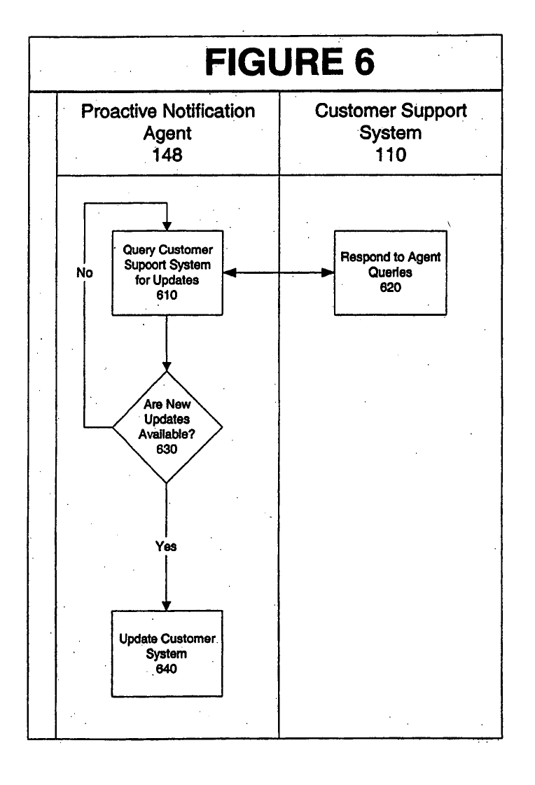

FIG. 6 is a flow chart of steps performed by agent 148 and customer support system 110. Agent 148 queries 610 customer support system 110 for application updates, alerts and new rules for processing. In step 620, agent 148 determines if new updates were returned by the query 610. If new updates were returned, agent 148 performs the actions required to update 640 the customer system 140 or process other received data. Among the updates provided by customer support system 110 are providing hot fixes, system reconfigurations, patches, adding or updating counters, rules, or thresholds for the agent database 240, and repairs. In the alternative, if the new updates were not returned, agent 148 continues to query 610 customer support system 110 for updates.

In addition, customer support system 110 is adapted to send “broadcast” communications to more than one customer system 140. For example, custom support system 110 can notify customer system 140 of availability of a new product release. Custom support system 110 is also capable of sending electronic messages including attachments to one or more customer system 140. Custom support system 110 is also capable of sending new counters to customer system 140. In another embodiment, new counters or instances of counters may be defined by a user through a consol 160 and then instituted in the proactive notification agent 148.

Similarly, customer support system 110 is capable of querying one or more customer systems 140 to gather reports and statistics. For example, customer support system 110 can issue a query to more than one customer system 140 for critical problems that are common for these systems.

Therefore, the instrumentation counters provide real time monitoring for performance, error, and transaction throughput in a healthcare information system. The notification agents enable both the customer support and the customers to proactively capture and fix the problems thereby achieving better workflow and enhancing the productivity in a healthcare enterprise setting.

It is to be understood that the description, specific examples and data, while indicating to limit the various embodiments, are given by way of illustration and are not intended to limit the various embodiments of the present disclosure. All references cited herein are specifically and entirely incorporated by reference. Various changes and modifications within the present disclosure will become apparent to the skilled artisan from the description and data contained herein, and thus are considered part of the various embodiments of this disclosure.

1. A method for proactively monitoring a healthcare information system, the method comprising:
monitoring one or more performance parameters of the healthcare information system by recording the values of the parameters by one of a plurality of counters;
comparing the value of the counters to thresholds; and
notifying a designated representative if the value of one of the plurality of counters exceeds one of the thresholds.

2. The method of claim 1, wherein the monitoring comprises polling the values of the parameters at a predetermined interval.

3. The method of claim 1, wherein said performance parameters comprise system performance parameters describing operational characteristics of the healthcare information system and business performance parameters describing operational characteristics of data processed by the healthcare information system.

4. The method of claim 3, wherein the system performance parameters are selected from the group consisting of free space on disk drives, status of power supply, status of network card, status of print queues, status of database backups, transaction logs of the database, number of outstanding database locks, status of SQL Server, status of SQL Server Agent, status of Microsoft Message Queue (MSMQ), status of Internet Information Server (IIS), network transaction throughput, CPU utilization, average response time of the user interface, repeated attempts to gain access to the system, and repeated attempts to gain unauthorized access to privileged data.

5. The method of claim 3, wherein the business performance parameters are selected from the group consisting of number of waiting patients, size of order entry queue, overdue diagnostic reports, and count of unresolved billing exceptions.

6. The method of claim 1, wherein the designated representative is an automated system.

7. The method of claim 1, wherein the designated representative is a user of the healthcare information system.

8. The method of claim 1, wherein the designated representative is a customer support representative of the healthcare information system.

9. The method of claim 1, wherein the notifying comprises routing a notification to a designated representative responsible for the healthcare information systems.

10. The method of claim 1, wherein the notifying comprises routing a notification to a designated representative responsible for the counter that exceeded the threshold.

11. The method of claim 1, wherein the threshold is defined by a user of the healthcare information system.

12. The method of claim 1, wherein the threshold is defined by a customer support system of the healthcare information system.

13. The method of claim 1, further comprising:
receiving from the designated representative an acknowledgement of receipt of the notification and an instruction of an action to be performed on the healthcare information system; and
performing the action to bring the value of the one of the plurality of counters back within the predetermined threshold.

14. The method of claim 1, wherein the notifying further comprises escalating the notification to a designated representative of a higher tier, when no acknowledgement is received after a predetermined period.

15. The method of claim 1, wherein the monitoring further comprises implementing one or more counter instances, capable of monitoring and recording specific aspects of a counter of the plurality, wherein the counter is a generic counter object.

16. The method of claim 1, wherein the comparing comprises transforming one of the performance parameters to a numeral, the numeral capable of being recorded by a counter.

17. The method of claim 1, further comprising displaying a user interface illustrating relationships between the counters and the thresholds.

18. A system for proactively monitoring a healthcare information system, the system comprising:
a plurality of counters, each of which capable of monitoring one of a multiplicity of performance parameters by recording the values of the one parameter; and
one or more notification agents, the agent capable of notifying a designated representative when the value of one of said plurality of counters exceeds a threshold.

19. The system of claim 18, further comprising an operator, capable of performing an action, in response to an instruction from the designated representation that the action be performed on the healthcare information system, to bring the value of the one of the plurality of counters back within the threshold.

20. The system of claim 19, wherein the operator is a human, wherein the action is performed manually.

21. The system of claim 20, wherein the operator is an automated system, wherein the action is performed automatically.

22. The system of claim 18, wherein the plurality of counters poll the values of the performance parameters at a predetermined interval.

23. The system of claim 18, wherein the performance parameters comprise system performance parameters describing operational characteristics of the healthcare information system and business performance parameters describing operational characteristics of data processed by the healthcare information system.

24. The system of claim 23, wherein the system performance parameters are selected from the group consisting of free space on disk drives, status of power supply, status of network card, status of print queues, status of database backups, transaction logs of the database, number of outstanding database locks, status of SQL Server, status of SQL Server Agent, status of Microsoft Message Queue (MSMQ), status of Internet Information Server (IIS), network transaction throughput, CPU utilization, average response time of the user interface, repeated attempts to gain access to the system, and repeated attempts to gain unauthorized access to privileged data.

25. The system of claim 23, wherein the business performance parameters are selected from the group consisting of number of waiting patients, size of order entry queue, overdue diagnostic reports, and count of unresolved billing exceptions.

26. The system of claim 18, wherein the designated representative is a human or an automated system.

27. The system of claim 18, wherein the designated representative is a user of the healthcare information system.

28. The system of claim 18, wherein the designated representative is a customer support representative of the healthcare information system.

29. The system of claim 18, wherein the notification agent is capable of routing a notification to a designated representative responsible for the counter of the plurality that exceeded the threshold.

30. The system of claim 18, wherein the notification agent is capable of routing a notification to a designated representative responsible for the healthcare information systems.

31. The system of claim 18, wherein the threshold is defined by a user of the healthcare information system.

32. The system of claim 18, wherein the threshold is defined by a customer support system of the healthcare information system.

33. The system of claim 18, wherein the one or more notification agents are further capable of escalating the notification to a designated representative of a higher tier, when no acknowledgement is received after a predetermined period.

34. The system of claim 18, wherein at least one of the plurality of counters is a generic counter object, wherein the generic counter object is capable of implementing one or more counter instances to monitor specific aspects of the corresponding performance parameters.

35. The system of claim 18, wherein at least one of the plurality of counters is capable of transforming one of the performance parameters to a numeral, the numeral capable of being recorded by a counter.

36. The system of claim 18, further comprising a first user interface, capable of illustrating relationships between the counters and the thresholds.

37. The system of claim 36, further comprising a second user interface, capable of illustrating relationships between the counters and the thresholds, wherein the first user interface is connected to a user of the healthcare information system, wherein the second user interface is connected to a customer support system of the healthcare information system.

39. A computer program product implementing the system of claim 18.

40. A computer readable medium having recorded thereon information on (i) the plurality of counters, (ii) the thresholds, and (iii) the designated representatives, of the system of claim 18.
